(19) United States
(12) Patent Application Publication
(10) Pub. No.: US 2024/0393822 A1
(43) Pub. Date: Nov. 28, 2024

(54) STICK DEVICE

(71) Applicant: NIDEC PRECISION CORPORATION, Tokyo (JP)

(72) Inventor: Shinya MIYAHARA, Tokyo (JP)

(21) Appl. No.: 18/669,437

(22) Filed: May 20, 2024

(30) Foreign Application Priority Data
May 26, 2023 (JP) 2023-087206

(51) Int. Cl. G05G 9/047

(52) U.S. Cl. CPC G05G 9/047; G05G 2009/04703; G05G 2009/04748; G05G 2009/04751; G05G 2009/04755; G05G 2009/04759

(57) ABSTRACT

A technique for a stick device improves durability or other characteristics. A stick device includes a stick rotatable about a first axis (X-axis), rotatable about a second axis (Y-axis), and pushable in a direction of a third axis (Z-axis) in response to an operation of a user, and a sensor that contactlessly detects a distance of a push on the stick or a position of the stick in the direction of the third axis (Z-axis).

### RELATED APPLICATIONS

The present application claims priority to Japanese Application Number 2023-087206, filed May 26, 2023, the disclosure of which is hereby incorporated by reference herein in its entirety.

### BACKGROUND

### Technical Field

The disclosure relates to a technique for a stick device.

### Description of the Background

A stick device is used as, for example, a controller (manipulator) in a game machine. A device such as a stick device with a known example technique or a controller including the stick device includes a detector for detecting the rotation angle (or the position) of a stick (in other words, a lever) and a detector for detecting any push on the stick or the distance of the push on the stick (or the position of the stick).

A stick device with a known example technique typically includes two potentiometers (variable resistors) for detecting, for example, the rotation angles of a first axis (defined as X-axis) and a second axis (defined as Y-axis) of a stick that are two axes perpendicular to each other, and a TACT Switch (registered trademark) for detecting a contact resulting from a downward push along a third axis (defined as Z-axis) perpendicular to the two axes of the stick. The TACT Switch is a contact switch or a push button switch.

Japanese Unexamined Patent Application Publication No. 2023-39410 (Patent Literature 1) describes a stick device with a known example technique. Patent Literature 1 describes a multi-directional input device with high efficiency and precision and low costs.

### CITATION LIST

### Patent Literature

Patent Literature 1: Japanese Unexamined Patent Application Publication No. 2023-39410

### BRIEF SUMMARY

A device such as a stick device with a known example technique or a controller including the stick device includes a detector for detecting, for example, the rotation angle of the stick and a detector for detecting, for example, the distance of a push on the stick. These detectors detect physical contacts. More specifically, a component such as a stick comes in contact with a detector component in response to the operation of a user. The components may thus be worn or degraded by the contact, and have issues in durability or other characteristics.

In the stick device with a known example technique, the potentiometers are fixed. When the stick is pushed downward (Z-axis), a portion of a first linkage is inclined downward together with the stick to come in contact with and push the TACT Switch. In the stick device with this structure, the load of the pressing force is concentrated on the inclined portion of the first linkage to cause the portion to bear a heavy contact load, and thus, the contact may wear or degrade the components.

The stick device including contact potentiometers may have a variable resistance changeable with long time use, and may inaccurately detect the rotation angle or the position of the stick. In other words, the stick device further has an issue in detection accuracy.

One or more aspects of the disclosure are directed to a technique for the stick device to improve durability or other characteristics.

An exemplary embodiment of the disclosure provides the structure described below. A stick device according to one embodiment includes a stick rotatable about a first axis, rotatable about a second axis, and pushable in a direction of a third axis in response to an operation of a user, and a sensor that contactlessly detects a distance of a push on the stick or a position of the stick in the direction of the third axis.

The technique for the stick device according to the exemplary embodiment of the disclosure improves durability or other characteristics. Issues, components, and effects other than the above are described in DETAILED DESCRIPTION below.

### BRIEF DESCRIPTION OF DRAWINGS

FIG. 1 is a perspective view of a stick device according to a first embodiment.

FIG. 2 is a perspective view of the stick device according to the first embodiment from which a cover is removed.

FIG. 3 is a YZ cross-sectional view of the stick device according to the first embodiment taken along line A-A.

FIG. 4 is an XZ cross-sectional view of the stick device according to the first embodiment taken along line B-B.

FIG. 5 is an XY plan view of the stick device according to the first embodiment as viewed from above.

FIG. 6 is a perspective view of a stick in the stick device according to the first embodiment.

FIG. 7 is a YZ plan view of the stick device according to the first embodiment.

FIG. 8 is a perspective view of a sensor board and a base housing included in the stick device according to the first embodiment.

FIG. 9 is a perspective view of an X-axis holder included in the stick device according to the first embodiment.

FIG. 10 is a perspective view of a Y-axis holder included in the stick device according to the first embodiment.

FIG. 11 is a perspective view of a stick receiving table included in the stick device according to the first embodiment.

FIG. 12 is a YZ cross-sectional view of the stick device according to the first embodiment when the stick is pushed.

FIG. 13 is an XZ plan view of the stick device according to the first embodiment before the stick is pushed.

FIG. 14 is an XZ plan view of the stick device according to the first embodiment after the stick is pushed.

FIG. 15 is an XZ plan view of the stick device according to the first embodiment when the stick is rotated.

FIG. 16 is an XZ plan view of the stick device according to the first embodiment when the stick is pushed and rotated.

FIG. 17A is a YZ cross-sectional view of the stick device according to the first embodiment, illustrating optical detection before the stick is pushed and rotated.

FIG. 17B is a YZ cross-sectional view of the stick device according to the first embodiment, illustrating optical detection after the stick is pushed and rotated.

FIG. 18A is an XY plan view of the stick device according to the first embodiment, illustrating optical detection before the stick is rotated.

FIG. 18B is an XY plan view of the stick device according to the first embodiment, illustrating optical detection after the stick is rotated.

FIG. 19 is a perspective view of the stick device according to the first embodiment to which a stick cover is attached.

### DETAILED DESCRIPTION

One or more embodiments of the disclosure will be described in detail below with reference to the drawings. In the drawings, like reference numerals basically denote like components. Such components will not be described repeatedly. For ease of understanding the disclosure, the components may not be shown, for example, at the actual positions with the actual size or shape, or within the actual range in the drawings, but are not limited to these.

For a process performed based on a program described in the example below, the program, a function, or a process unit may be focused as an implementation. Such a process may be implemented by hardware such as a processor, or a controller (control device), a computer, or a system including the processor. The computer performs, with the processor, the process based on the program read on a memory while using resources such as a memory and a communication interface as appropriate. Thus, a predetermined function or a process unit is implemented. The processor may be, for example, a semiconductor device such as a central processing unit (CPU), a microprocessor unit (MPU), or a graphics processing unit (GPU). The process may be implemented with a dedicated circuit, rather than processing based on a software program. For example, a field-programmable gate array (FPGA), an application-specific integrated circuit (ASIC), or a complex programmable logic device (CPLD) is usable as a dedicated circuit.

The program may be preliminarily installed on a target computer as data, or distributed from a program source to a target computer as data. The program source may be a program distribution server on a communication network or a non-transitory computer-readable recording medium such as a memory card or a disk. The program may include multiple modules. The computer system may include multiple devices. The computer system may include, for example, a client-server system, a cloud computing system, or an Internet of things (IoT) system. Each type of data or information may be stored in, for example, a table or a list, but may be stored in another form. Identification, an identifier, ID, a name, and a number may be replaceable with one another.

### Overview of Embodiments

A stick device according to the present embodiment includes a contactless sensor to detect, for example, the rotation angle of a stick and the distance of a push on the stick without known potentiometers or a known TACT Switch. A component such as the stick or a linkage does not come in contact with a detection component such as the TACT Switch.

In the stick device according to the present embodiment, when the stick is pushed downward in Z-direction in response to a user operation, a first linkage moves downward while retaining its full portion, including both ends, substantially at the same height position (in other words, while retaining a substantially parallel orientation in an XY plane), rather than moving downward with simply one end being inclined. In this state, the stick device according to the present embodiment or a controller device including the stick device detects the distance of a push on the stick or the position of the stick with a contactless sensor, for example, an optical sensor.

In the stick device according to the present embodiment, a component such as the stick or the linkage does not come in contact with the detection component. Thus, the stick device can prevent or reduce wear or degradation of the components resulting from contacts and thus increase durability.

In response to the above, one or more embodiments are directed to a structure that can contactlessly detect a push on the stick and a rotation of the stick.

The stick device according to the embodiment can incline the stick with rotation of a rotator (in other words, a first linkage and a second linkage) about X-axis and Y-axis in response to a user operation on the stick, and includes a detector for detecting the inclination (rotation angle or rotation position) of the stick with a contactless sensor (e.g., an optical sensor). In some embodiments, the contactless sensor may be, for example, a magnetic sensor.

The stick device according to the embodiment allows the user to push the stick downward from above in Z-direction. In addition to the push, the stick is also rotatable about two axes (X-axis and Y-axis, or in other words, rotatable within the XY plane).

The contactless sensor, for example, an optical sensor, detects or measures the distance to the stick or the position of the stick. When the stick is pushed downward from an upper reference position, for example, light emitted from the optical sensor is incident on and reflected from the stick bottom. The optical sensor detects the reflected light. The optical sensor or a sensor board receiving the optical sensor can detect or calculate the distance to the stick or the position of the stick based on a signal indicating the light emission or light reception, and output the distance or the position. The sensor board or a device on which the stick device is mounted can detect or calculate the amount of the push on the stick based on the distance to the stick or the position of the stick.

The stick device can further detect or calculate the biaxial (X-axis and Y-axis) rotation angle or the position of the stick using the contactless sensor. For example, the distance or the direction of light emitted from the optical sensor and returning as reflected light after being incident on the stick bottom changes based on the rotation angle or the position of the stick. Thus, the optical sensor or the sensor board can detect or calculate the biaxial rotation angle or the position of the stick based on the reception of light.

The stick device according to the embodiment can contactlessly detect the push amount of the stick and the rotation angle or the position of the stick. The contactless detection can prevent or reduce wear or degradation of the components and increase durability.

The stick device according to the embodiment allows the user to freely rotate the stick in biaxial (X-axis and Y-axis) directions while pushing the stick downward in Z-direction. More specifically, the stick device and a controller device including the stick device allow rotation of the stick in the biaxial directions while the stick is being pushed.

### First Embodiment

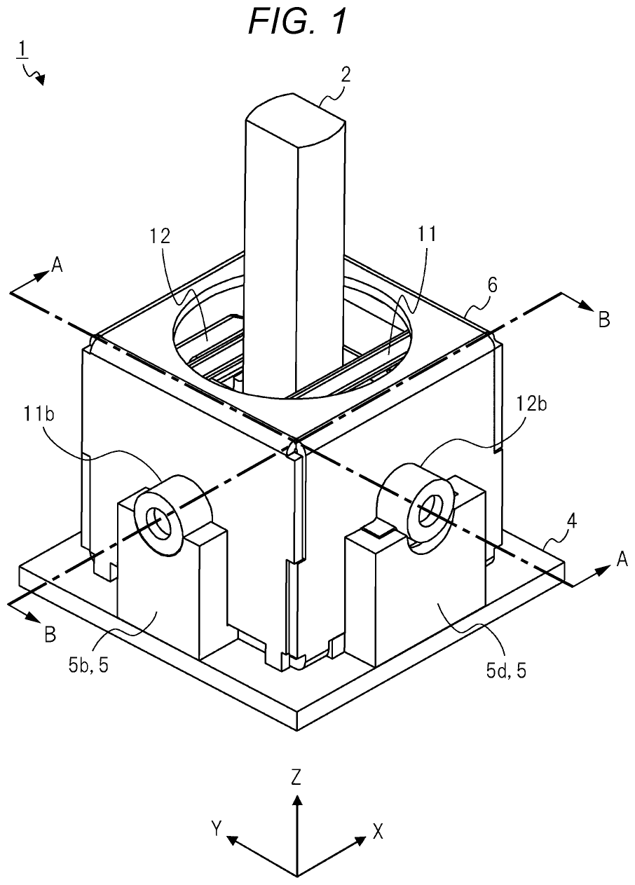

With reference to FIGS. 1 to 19, a stick device according to a first embodiment of the disclosure will be described.

### Stick Device

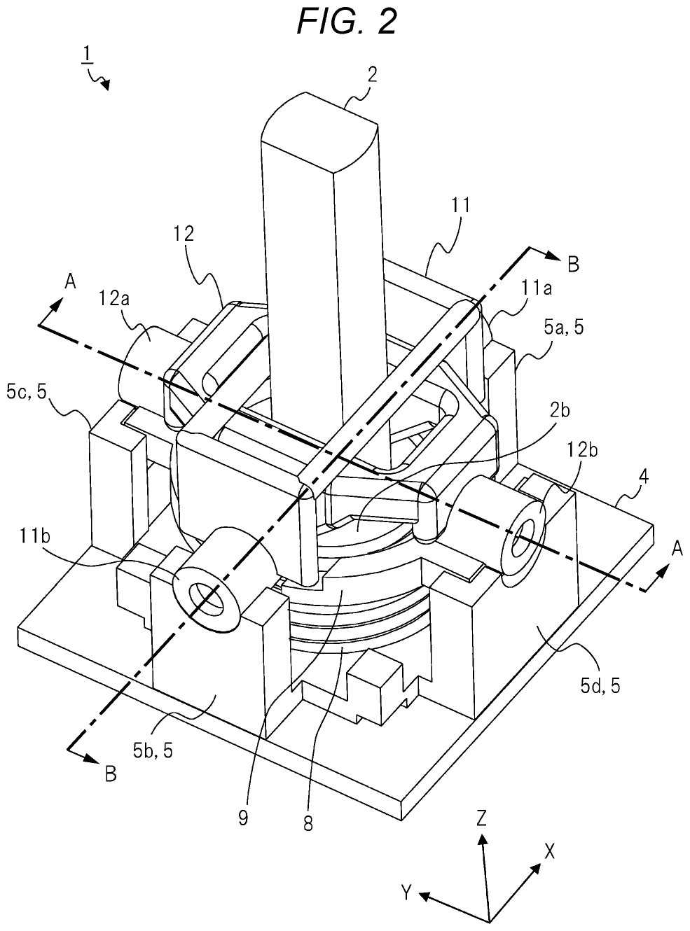

FIG. 1 is a perspective view of a stick device 1 according to the first embodiment. Line A-A corresponds to a second axis, or for example, Y-axis (a vertical operation axis viewed from the user) for a stick operation, and line B-B corresponds to a first axis, or for example, X-axis (a horizontal operation axis viewed from the user) for the stick operation. FIG. 2 is a perspective view of the stick device 1 in FIG. 1 from which a cover 6 is removed.

As shown in FIGS. 1 and 2, the stick device 1 includes, in order from the bottom substantially in Z-direction, a sensor board 4, a base housing 5, a spring 8, a stick mount 9, a Y-axis holder 12, an X-axis holder 11, the cover 6, and a stick 2.

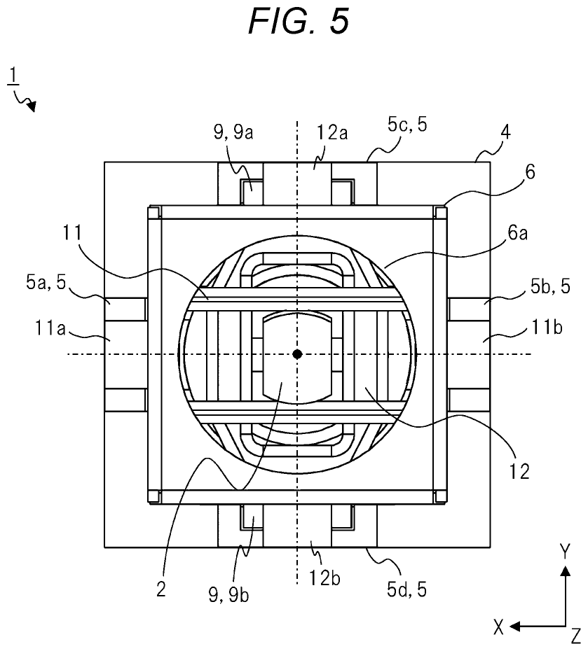

FIG. 1 mainly shows an upper portion of the stick 2, the cover 6, a first shank 11b in the X-axis holder 11, a first shank 12b in the Y-axis holder 12, supporters 5b and 5d in the base housing 5, and the sensor board 4. The cover 6 covers an assembly including the X-axis holder 11. The cover 6 has a circular opening 6a (FIG. 5 referred to later) in an upper surface. The opening 6a receives the stick 2 placed in Z-direction, and exposes parts of the X-axis holder 11 and the Y-axis holder 12.

The assembly including the X-axis holder 11, the Y-axis holder 12, the stick mount 9, and an optical sensor 7 in the present embodiment differs from an assembly including two potentiometers, a holder (linkage), and a TACT Switch in a contact stick device with a known example technique.

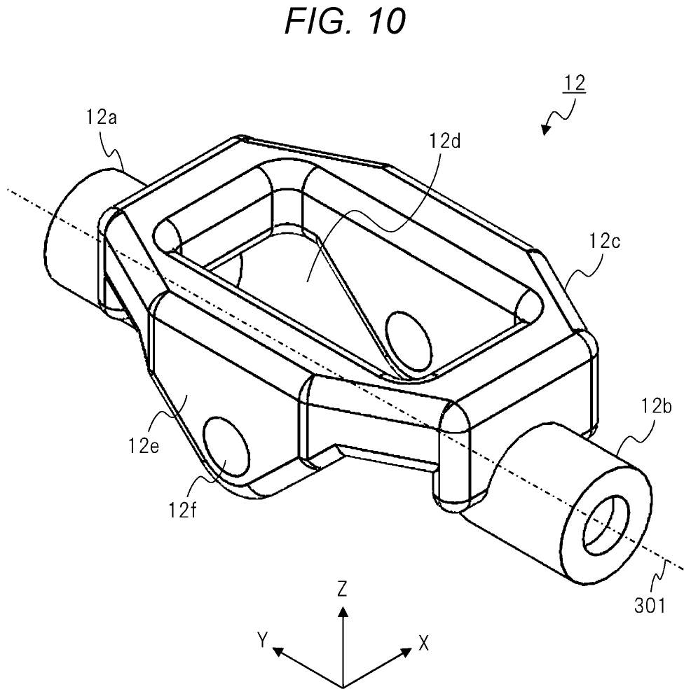

FIG. 2 shows a lower portion of the stick 2 (including a stick bottom 2b) that receives the X-axis holder 11 and the Y-axis holder 12, and the stick mount 9 that receives the Y-axis holder 12 and accommodates the stick bottom 2b. In FIG. 2, the space defined by the base housing 5 accommodates the spring 8, the stick mount 9, the Y-axis holder 12, and the X-axis holder 11. A supporter 5a and a supporter 5b in the base housing 5 arranged in X-direction support a shank 11a and a shank 11b in the X-axis holder 11. A supporter 5c and the supporter 5d in the base housing 5 arranged in Y-direction support a supporter 9a and a supporter 9b (FIG. 11 referred to later) in the stick mount 9 and a shank 12a and a shank 12b in the Y-axis holder 12.

FIGS. 1 and 2 show the stick 2 not operated (or at a neutral position or a normal position). At the neutral position, the stick 2 is located at, as a reference position, a predetermined maximum position (in other words, a highest position) in Z-direction, and predetermined middle positions in X-direction and Y-direction.

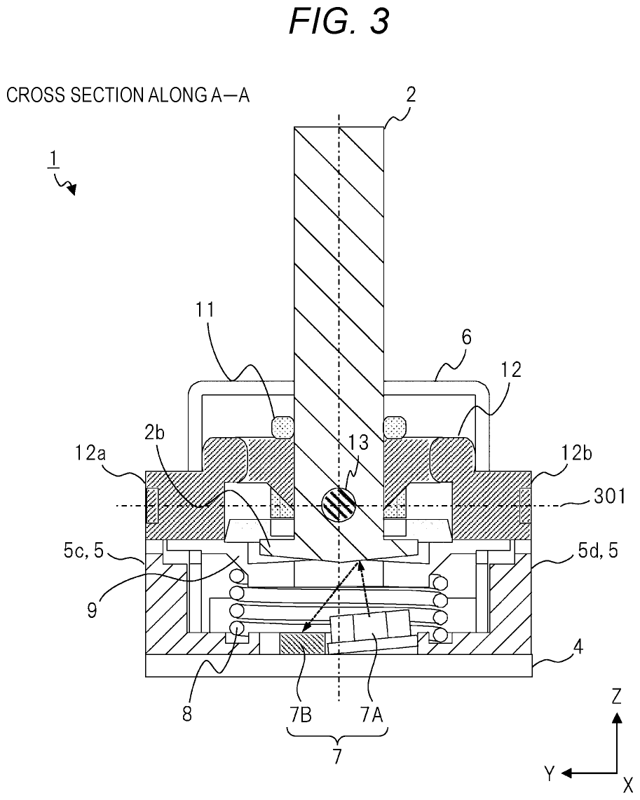

The stick device 1 according to the first embodiment in FIG. 1 includes the sensor board 4 including the optical sensor 7 (e.g., FIG. 3 referred to later) for optical detection. In the first embodiment, the sensor board 4 including the optical sensor 7 is also a component of the stick device 1. In another embodiment, the sensor board 4 including the optical sensor 7 may be a component externally attached to the stick device 1. The sensor board 4 may be included in, for example, a controller device including the stick device 1.

### Stick Cover

FIG. 1 shows the structure without a stick cover 3 (in other words, a stick head) illustrated in FIG. 19. FIG. 19 is a perspective view of the stick 2 in the stick device 1 in FIG. 1 to which the stick cover 3 is attached. The stick cover 3 is fixed to an upper portion of the stick 2. The stick cover 3 allows the user to operate the stick with fingers in a triaxial direction.

### YZ Cross-Sectional View

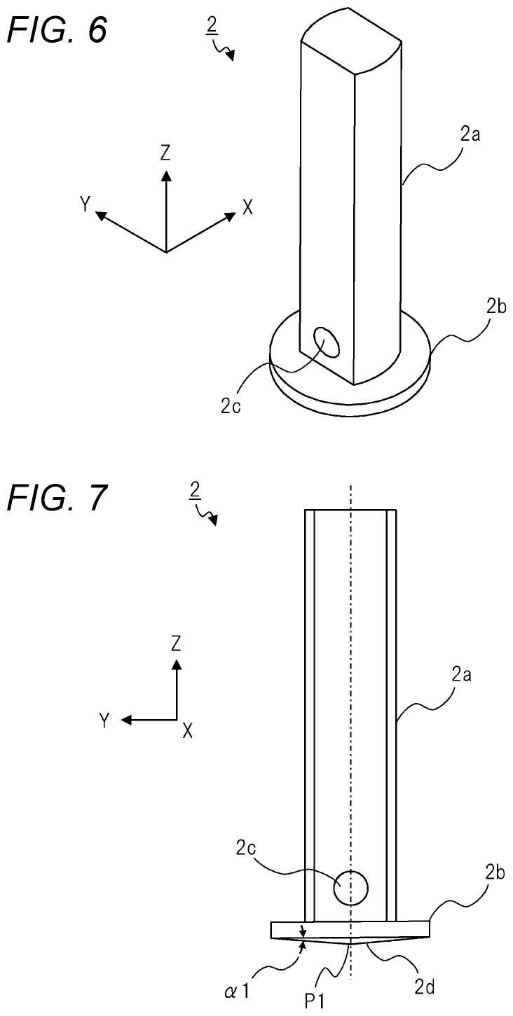

FIG. 3 is a cross-sectional view (YZ cross-sectional view) of the stick device 1 in FIG. 1 taken along line A-A corresponding to Y-axis. The dot-dash line extending in Z-direction indicates the central axis. FIG. 3 shows, in the stick device 1, the optical sensor 7 (a light emitter 7A and a light receiver 7B) mounted on the sensor board 4, and the spring 8 placed on the base housing 5. FIG. 3 further shows the stick mount 9 supported on the spring 8 and the base housing 5, the Y-axis holder 12 supported on the stick mount 9, and the X-axis holder 11 receiving the Y-axis holder 12 placed in Y-direction. FIG. 3 further shows a shaft 13 connecting the Y-axis holder 12 and the stick 2. As illustrated in the figure, the stick 2 extends through, in order from above in Z-direction, the X-axis holder 11 and the Y-axis holder 12, and the stick bottom 2b (FIG. 6 referred to later) is received in a recess 9d (FIG. 11 referred to later) on the stick mount 9.

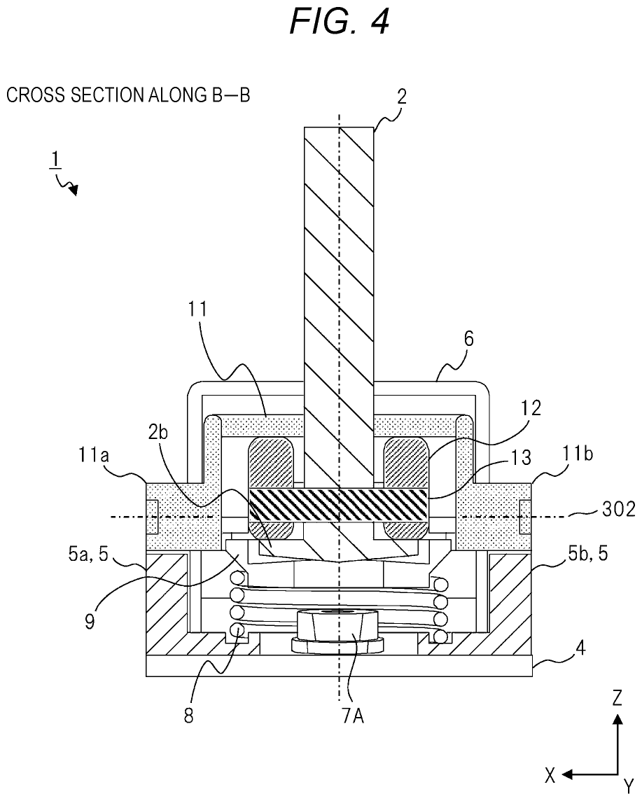

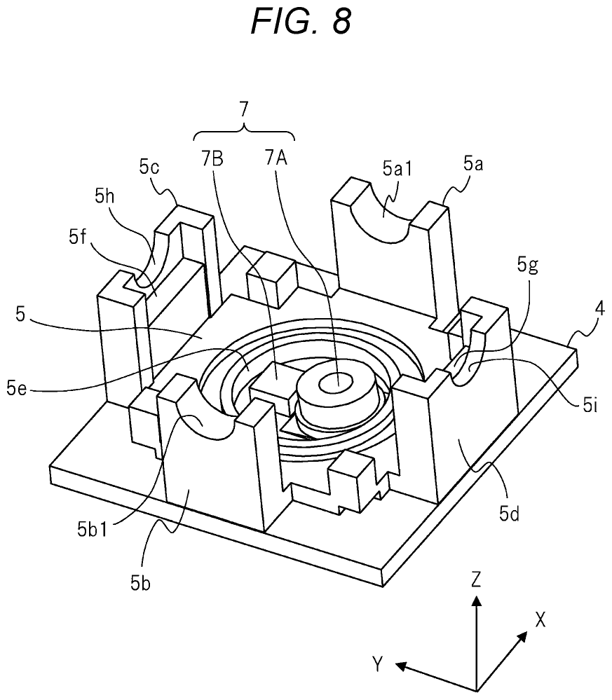

As shown in FIGS. 3 and 4, in the present embodiment, the optical sensor 7 being a contactless sensor is located near the central axis (at a predetermined position in an opening 5e in FIG. 8) below the stick bottom 2b of the stick 2 in Z-direction, and below the stick mount 9 in Z-direction. The optical sensor 7 may be at any position to emit light to the stick bottom 2b and receive reflected light. The height position of the shaft 13 is the same as the height position of a rotation central axis 301 of the shanks 12a and 12b in the Y-axis holder 12 extending in Y-direction.

In the present embodiment, the optical sensor 7 includes the light emitter 7A and the light receiver 7B as a pair. The light emitter 7A is, for example, a laser device. The sensor board 4 controls the light emitter 7A in the optical sensor 7 to emit light. Light (e.g., laser light) emitted from the light emitter 7A passes through an opening 9e (FIG. 11 referred to later) in the stick mount 9 as indicated with the arrow, and is applied to the bottom surface of the stick bottom 2b. The applied light is reflected from the bottom surface of the stick bottom 2b, and the reflected light is received by the light receiver 7B. The sensor board 4 controls the light receiver 7B in the optical sensor 7, and receives a detection signal from the light receiver 7B.

The sensor board 4 may output a detection signal from the optical sensor 7 or a signal resulting from a predetermined process performed on the detection signal through a terminal to an external device (e.g., a controller device). The sensor board 4 may also output the detection signal or another signal to an external device through wireless or wired communication. The predetermined process may include calculation of the push distance or the rotation angle.

### XZ Cross-Sectional View

FIG. 4 is a cross-sectional view (XZ cross-sectional view) of the stick device 1 in FIG. 1 taken along line B-B corresponding to X-axis. FIG. 4 shows, in the stick device 1, the light emitter 7A in the optical sensor 7 mounted on the sensor board 4, and the spring 8 on the base housing 5. FIG. 4 further shows the stick mount 9 supported on the spring 8, the X-axis holder 11 supported on the base housing 5, and the Y-axis holder 12 received in the X-axis holder 11 placed in Y-direction. FIG. 4 further shows the shaft 13 connecting the Y-axis holder 12 and the stick 2. The shaft 13 extends in X-direction. As illustrated in the figure, the stick 2 extends through, in order from above in Z-direction, the X-axis holder 11 and the Y-axis holder 12, and the stick bottom 2b (FIG. 6 referred to later) is received in the recess 9d (FIG. 11 referred to later) on the stick mount 9.

The height position of a rotation central axis 302 of the shanks 11a and 11b in the X-axis holder 11 extending in X-direction is slightly below the shaft 13 and the rotation central axis 301 of the Y-axis holder 12 in FIG. 3.

### XY Plane View

FIG. 5 is an XY plane view of the stick device 1 in FIG. 1 as viewed from above. The cover 6 has, for example, the circular opening 6a in its upper surface. The stick 2 has its upper portion protruding upward in Z-direction through the opening 6a, through which parts of the X-axis holder 11, the Y-axis holder 12, and the stick mount 9 are viewable. The black dot as a point of intersection of the dot-dash lines represents the central axis (Z-axis) of the stick 2. The stick 2 is rotatable in XY-direction within the range of the circular opening 6a. The supporters 5a, 5b, 5c, and 5d in the base housing 5 protrude outward from the cover 6. The supporters 5a and 5b in the base housing 5 support the X-axis holder 11 in a rotatable manner. The supporters 5c and 5d in the base housing 5 support the Y-axis holder 12 in a rotatable manner.

### Stick

FIG. 6 is a perspective view of the stick 2. The stick 2 includes a stick body 2a extending along Z-axis, and the stick bottom 2b in its lower portion. In this example, the stick body 2a has a barrel shape in a XY cross section, planar surfaces on both side surfaces in X-direction, and convex surfaces on both side surfaces in Y-direction, but may have another shape. The stick body 2a has a shaft hole 2c in its lower portion, through which the shaft 13 extends in X-direction and to which the shaft 13 is fixed. The stick bottom 2b is substantially disk-shaped, with its upper surface aligned with an XY plane. The disk has a greater diameter than the stick body 2a.

FIG. 7 is a YZ plane view of the stick 2. In the present embodiment, the stick bottom 2b has a bottom surface 2d protruding downward in Z-direction to have a conical shape. A point P1 serving as an apex of the cone is aligned with the central axis (dot-dash line) of the stick 2. The cone has a tilt at a predetermined angle α1. The angle α1 of the tilt is set to facilitate detection with the optical sensor 7.

In the present embodiment, the bottom surface 2d of the stick bottom 2b has the above conical surface as a predetermined shape. This conical surface is an example, and the shape is not limited to this. For example, the cone may have a surface extending along an XY plane or a curved surface around the apex. The bottom surface 2d may have a curved surface such as a spherical surface or an elliptic surface, rather than the conical surface.

### Sensor Board and Base Housing

FIG. 8 is a perspective view of the sensor board 4 and the base housing 5. The sensor board 4 receives the optical sensor 7 (the light emitter 7A and the light receiver 7B) at, for example, a predetermined position on an upper surface of a rectangular flat plate near the center. In this example, the optical sensor 7 includes the light emitter 7A and the light receiver 7B as a pair. In some embodiments, the optical sensor 7 may be an integral sensor device. The sensor board 4 may receive other components such as an electronic circuit.

The base housing 5 is fixed to the sensor board 4. The base housing 5 holds the spring 8, the stick mount 9, the X-axis holder 11, the Y-axis holder 12, and the cover 6. The base housing 5 includes a flat plate in an XY plane having the opening 5e at the center, and supporters (supporters 5a, 5b, 5c, and 5d) protruding from the flat plate in Z-direction at both ends in X-direction and Y-direction. The optical sensor 7 (the light emitter 7A and the light receiver 7B) is received in the opening 5e in the flat plate. An annular groove surrounds the opening 5e, and the spring 8 (FIGS. 2 to 4) is received in the groove.

The base housing 5 includes the supporters 5a and 5b arranged in X-direction and the supporters 5c and 5d arranged in Y-direction. The supporters 5a, 5b, 5c, and 5d each have a flat portion standing at upper positions in Z-direction.

As shown in FIGS. 1 to 5 and 8, the supporters 5a and 5b in the base housing 5 arranged in X-direction protrude outward from the cover 6. In other words, the supporters 5a and 5b are X-axis holder supporters. As shown in, for example, FIG. 8, the supporter 5a has a semicircular recess 5al, and the supporter 5b has a semicircular recess 5b1. The recesses 5al and 5b1 support the shanks 11a and 11b in the X-axis holder 11 at upper positions in Z-direction.

The supporters 5c and 5d in the base housing 5 arranged in Y-direction protrude outward from the cover 6. In other words, the supporters 5c and 5d are Y-axis holder supporters. The supporter 5c has a semicircular recess 5h as an outer recess, and a rectangular recess 5f as an inner recess. The supporter 5d has a semicircular recess 5i as an outer recess, and a rectangular recess 5g as an inner recess. The rectangular recesses 5f and 5g as the inner recesses support the supporters 9a and 9b in the stick mount 9 (FIG. 11). The semicircular recesses 5h and 5i as the outer recesses support the shanks 12a and 12b in the Y-axis holder 12.

As shown in FIGS. 8 and 3, the recesses 5f and 5g as the inner recesses in Y-direction are deeper in Z-direction than the recesses 5h and 5i as the outer recesses. Thus, as shown in, for example, FIG. 2, with the supporters 9a and 9b in the stick mount 9 being supported on the recesses 5f and 5g as the inner recesses, each of the semicircular recesses (recesses 9al and 9b1 in FIG. 11) on the supporters 9a and 9b and the corresponding one of the semicircular recesses 5h and 5i as the outer recesses define a continuous recess. The shanks 12a and 12b in the Y-axis holder 12 are supported in the continuous recesses.

### X-Axis Holder

FIG. 9 is a perspective view of the X-axis holder 11 (in other words, the first linkage). The X-axis holder 11 includes the shanks 11a and 11b arranged in X-direction and a stick receptacle 11c extending in X-direction between the shanks 11a and 11b. The shanks 11a and 11b are cylinders rotatable about X-axis (rotation central axis 302), and supported on the supporters 5a and 5b in the base housing 5 (FIGS. 5 and 8) in a rotatable manner.

The stick receptacle 11c receives the stick body 2a (FIG. 6) placed in Z-direction. The stick receptacle 11c is substantially a box having side surfaces arranged in X-direction and to which the shanks 11a and 11b are fixed and having four sides of the upper surface in Z-direction. The four sides define a substantially rectangular opening 11d. When operated in X-direction, the stick body 2a is rotatable in X-direction in the opening 11d of the stick receptacle 11c within a range until coming in contact with the left side or the right side of the stick receptacle 11c in the X-direction. When operated in Y-direction, together with the X-axis holder 11, the stick body 2a is rotatable in Y-direction in the opening 11d of the stick receptacle 11c within a range until coming in contact with the upper side or the lower side of the stick receptacle 11c in Y-direction, and until coming in contact with the upper side or the lower side of the Y-axis holder 12 in Y-direction (e.g., FIGS. 2 and 5).

### Y-Axis Holder

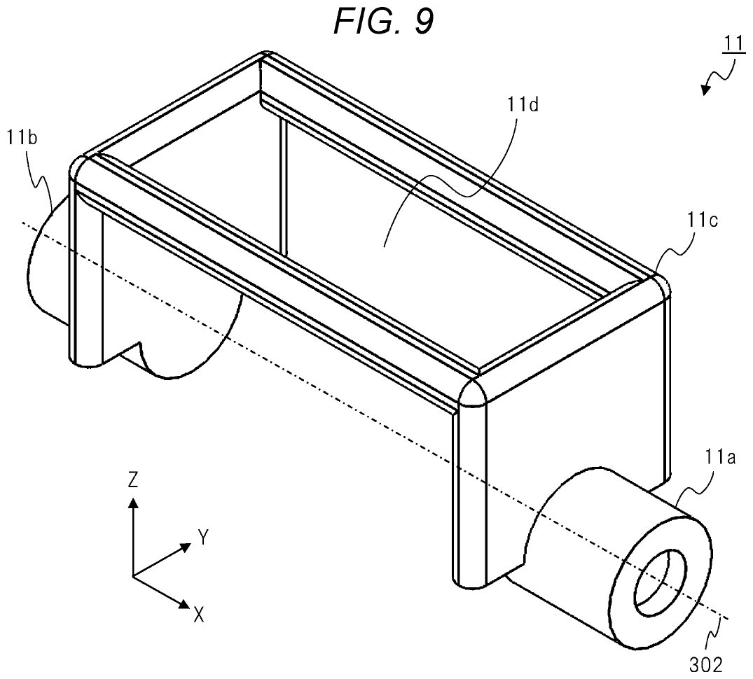

FIG. 10 is a perspective view of the Y-axis holder 12 (in other words, the second linkage). The Y-axis holder 12 includes the shanks 12a and 12b arranged in Y-direction and a stick receptacle 12c extending in Y-direction between the shanks 12a and 12b. The shanks 12a and 12b are cylinders rotatable about Y-axis (rotation central axis 301), and supported on the supporters 5c and 5d in the base housing 5 (FIGS. 5 and 8) in a rotatable manner.

The stick receptacle 12c receives the stick body 2a placed in Z-direction. The stick receptacle 12c is substantially a box having side surfaces arranged in Y-direction and to which the shanks 12a and 12b are fixed and having four sides of the upper surface in Z-direction. The four sides define a substantially rectangular opening 12d. The stick receptacle 12c also has side portions 12e corresponding to the left and right sides in X-direction, and the side portions 12e each have a shaft hole 12f into which the shaft 13 (FIGS. 3 and 4) is placed and to which the shaft 13 is fixed.

When operated in Y-direction, the stick body 2a is rotatable in Y-direction in the opening 12d in the upper surface of the stick receptacle 12c with the shaft 13 within a range until coming in contact with the upper side or the lower side of the stick receptacle 12c in Y-direction. When operated in X-direction, the stick body 2a is rotatable in X-direction with the shaft 13 together with the Y-axis holder 12 within a range until coming in contact with the left side or the right side of the X-axis holder 11 in X-direction (e.g., FIGS. 2 and 5).

### Stick Mount

FIG. 11 is a perspective view of the stick mount 9. The stick mount 9 includes the supporters 9a and 9b protruding outward in Y-direction from a pad 9c with a disk shape. The pad 9c has the circular recess 9d about Z-axis and having a first diameter and a first depth from the upper surface and the circular opening 9e having a second diameter and a second depth from the upper surface of the recess 9d.

As described above, the supporters 9a and 9b arranged in Y-direction are supported on the recesses 5f and 5g as the inner recesses on the supporters 5c and 5d in the base housing 5 (e.g., FIG. 8) arranged in Y-direction. The semicircular recesses 9al and 9b1 are located on the upper surfaces of the supporters 9a and 9b. As shown in, for example, FIGS. 1, 2, and 3, the shanks 12a and 12b in the Y-axis holder 12 (FIG. 10) are supported on the recesses 9al and 9b1.

The pad 9c has cutouts 9f and 9g at both ends in X-direction around its outer periphery. As shown in FIG. 4, the shanks 11a and 11b in the X-axis holder 11 are in the cutouts 9f and 9g.

As shown in, for example, FIGS. 2 to 4, the stick bottom 2b (e.g., FIG. 6), in particular, the outer periphery of the stick bottom 2b is supported in the recess 9d on the pad 9c. In particular, the stick bottom 2b has a center portion including the apex of the cone exposed through the opening 9e in the recess 9d in its lower portion in Z-direction. More specifically, light from the optical sensor 7 is applied to the bottom surface 2d at the center of the stick bottom 2b through the opening 9e aligned with Z-axis (central axis).

With the shanks in the X-axis holder 11, the shanks in the Y-axis holder 12, and the supporters in the stick mount 9 supported on the supporters in the base housing 5, the cover 6 is attached above these components as shown in FIG. 1. The shanks in the X-axis holder 11 and the shanks in the Y-axis holder 12 are received in semicircular recesses on the cover 6. Thus, the base housing 5 and the cover 6 limit the movable ranges of the X-axis holder 11, the Y-axis holder 12, and the stick mount 9.

Operation of Stick when Pushed

An operation of the stick 2 pushed downward in Z-direction will be described. As described in FIGS. 1 to 5, for example, the stick device 1 at a neutral position has the stick 2 extending in Z-direction at a reference position and has the X-axis holder 11 and the Y-axis holder 12 at predetermined reference positions on the base housing 5. At the neutral position, the shanks 12a and 12b in the Y-axis holder 12 are each located above the corresponding one of the recesses 5h and 5i on the supporters 5c and 5d in the base housing 5 at a distance. The shanks 12a and 12b in the Y-axis holder 12 are in contact with the supporters 9a and 9b in the stick mount 9 without being in contact with the recesses 5h and 5i on the supporters 5c and 5d in the base housing 5.

When the user does not operate the stick device 1, or in other words, when the user does not touch the stick 2 with fingers, or when the user does not apply a force on the stick 2, the stick 2 remains at the neutral position (in other words, the reference position or a normal position) with, for example, the force of the spring 8. At the neutral position, the stick 2 is at the center along X-axis and Y-axis, the rotation angle is zero degrees, the distance of a push on the stick 2 in Z-direction is zero, and the stick 2 is at the highest position.

As shown in FIGS. 3 and 4, the stick mount 9 (outer periphery of the pad 9c in FIG. 11) has a part supported on the upper portion of the spring 8. When the stick 2 is pushed downward in Z-direction, a part of the stick mount 9 comes in contact with the spring 8 and receives an elastic force from the spring 8 upward in Z-direction. Thus, when the user stops applying a force on the stick 2, the stick 2, the Y-axis holder 12, and the stick mount 9 return to a predetermined upper position in Z-direction.

The effect of the stick 2 pushed downward in Z-direction will be described. The rotation in XY-direction of the stick 2 being pushed is zero in this example. When the stick 2 is pushed downward in Z-direction, the X-axis holder 11 does not move in Z-direction. In contrast, the Y-axis holder 12, connected to the stick 2 with the shaft 13, moves downward in Z-direction together with the stick 2 while retaining its full portion in an orientation substantially parallel to the XY plane.

The shanks 12a and 12b in the Y-axis holder 12 are supported on the supporters 9a and 9b in the stick mount 9 (FIG. 3). Thus, the stick mount 9 is also pushed downward in Z-direction with the downward movement in Z-direction of the stick 2 and the Y-axis holder 12. The stick mount 9 also moves downward in Z-direction while retaining its full portion in an orientation substantially parallel to the XY plane.

Thus, the stick 2, the Y-axis holder 12, and the stick mount 9 integrally move downward in Z-direction within the range until being stopped by the recesses 5h and 5i and the recesses 5f and 5g on the supporters 5c and 5d in the base housing 5. The positions at which the stick 2, the Y-axis holder 12, and the stick mount 9 are stopped correspond to the minimum positions (lowest position) in Z-direction.

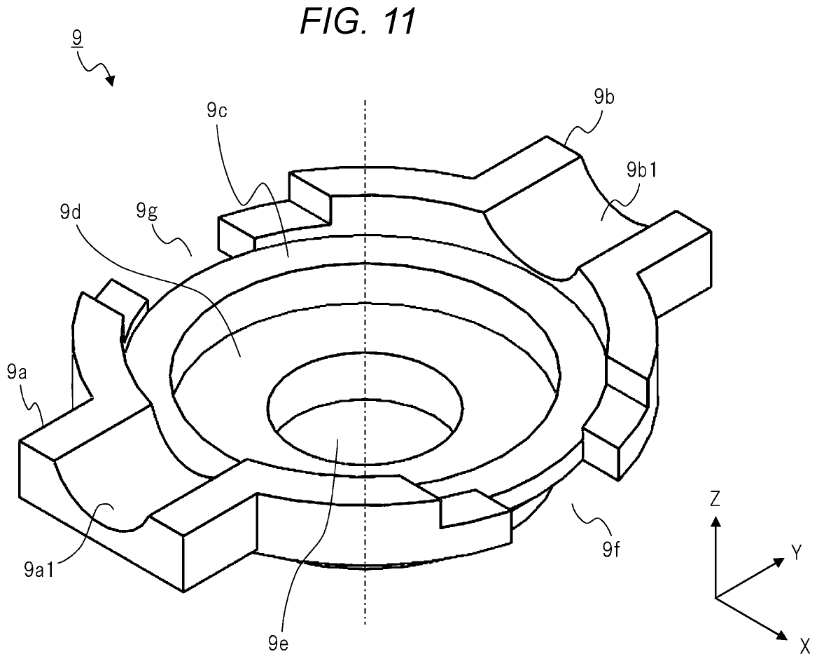

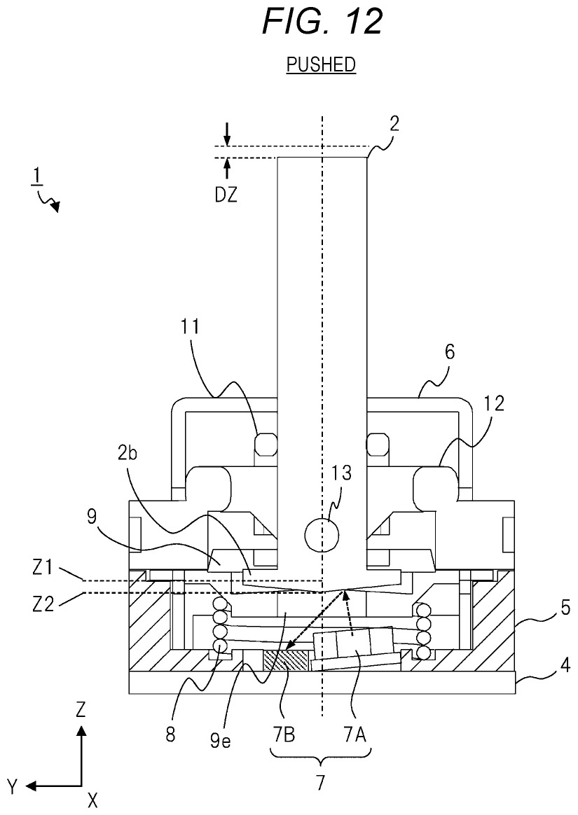

FIG. 12 is a YZ cross-sectional view of the stick 2 pushed downward in Z-direction to a predetermined minimum position (lowest position). In the example shown in FIG. 12, the user pushes the stick 2 downward in Z-direction by a distance DZ. The rotation in XY-direction is zero in this case. This push changes the position of the apex of the central axis of the bottom surface 2d of the stick bottom 2b, serving as the height position in Z-direction, from a position Z1 to a position Z2.

In the state in FIG. 12, the bottom surface 2d of the stick bottom 2b is rotatable in XY-direction as described below, without being in contact with the recess 9d (FIG. 11) around the opening 9e in the stick mount 9. In other words, to allow rotation in XY-direction while being pushed, the bottom surface 2d of the stick 2 and the opening 9e in the stick mount 9 have predetermined shapes to leave a predetermined distance between them.

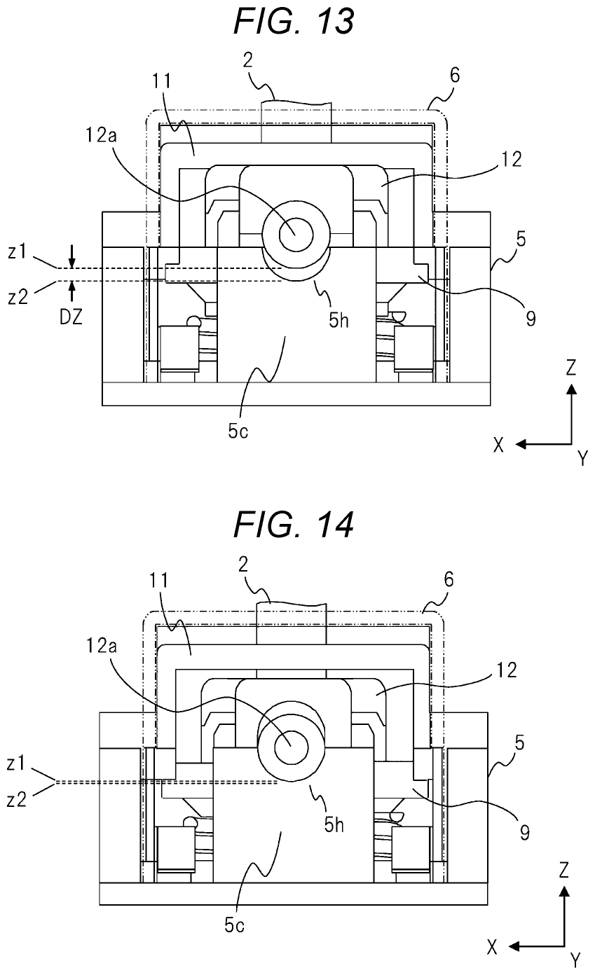

FIG. 13 is an XZ side view of the stick 2 in FIG. 4 at the neutral position, or more specifically, at the maximum position (highest position) in Z-direction before the stick 2 is pushed. FIG. 13 shows the cover 6 with the two-dot-dash lines. FIG. 13 shows the semicircular recess 5h and the supporter 5c in Y-direction in the base housing 5. The shank 12a in the Y-axis holder 12 is placed above the recess 5h at a distance (corresponding to the distance DZ). The lower end position of the shank 12a is denoted with z1, and the lower end position of the recess 5h is denoted with z2.

In FIG. 13, the stick mount 9 and the Y-axis holder 12 are raised by the spring 8. The rotation central axis 302 (and the shanks 11a and 11b corresponding to the rotation central axis 302) of the X-axis holder 11 is supported by the supporters 5a and 5b in the base housing 5, and thus the rotation position remains unchanged. The rotation central axis 301 (and the shanks 12a and 12b corresponding to the rotation central axis 301) in the Y-axis holder 12 is not in contact with the supporters 5c and 5d in the base housing 5, but is in contact with and supported by the supporters 9a and 9b in the stick mount 9. When the spring 8 has a sufficiently high spring force, the stick 2 is rotatable about the stick mount 9 also at the position in FIG. 13.

FIG. 14 is an XZ side view of the stick 2 in FIGS. 4 and 12 at the minimum position (lowest position) in Z-direction after the stick 2 is pushed at the position in FIG. 13. The shank 12a in the Y-axis holder 12 is stopped from moving downward in Z-direction by the recess 5h, and the lower end position z1 of the shank 12a is substantially aligned with the lower end position z2 of the recess 5h without a gap left between them.

In FIG. 14, the stick 2 is pushed with a force greater than the spring force of the spring 8 to lower the stick mount 9 and the Y-axis holder 12 downward in Z-direction together with the stick 2. When the stick 2 is pushed to the predetermined minimum position (lowest position), the stick mount 9 comes in contact with the supporters 5c and 5d (recesses 5f and 5g) in the base housing 5, and the rotation central axis 301 (shanks 12a and 12b) of the Y-axis holder 12 also comes in contact with the supporters 5c and 5d (recesses 5h and 5i) of the base housing 5 (e.g., FIGS. 3 and 12).

FIGS. 13 and 14 simply show one end portion of the stick 2 along Y-axis, but the other end portion also has the same structure. When the user releases the stick 2 at the position in FIG. 14, the spring force of the spring 8 returns the stick 2, the Y-axis holder 12, and the stick mount 9 to the predetermined reference positions.

When the stick 2, the Y-axis holder 12, and the stick mount 9 move downward in Z-direction, the Y-axis holder 12 and the stick mount 9 move while remaining substantially in horizontal orientations, and the contact portions that bear the load of a push are dispersed over multiple portions. More specifically, the contact portions that mainly bear the load include the shanks 12a and 12b in the Y-axis holder 12, the supporters 9a and 9b in the stick mount 9, and the supporters 5c and 5d in the base housing 5. This dispersion of force further prevents or reduces, for example, wear of the components under the load applied when pushed, as compared with a known assembly.

### Optical Detection at Push on Stick

The push distance or the position in Z-direction is detected by the optical sensor 7 in the manner described below when the stick 2 is pushed downward in Z-direction.

As shown in FIG. 3 or 12, the optical sensor 7 emits light to the bottom surface 2d of the stick bottom 2b with the light emitter 7A. The light reflected from the bottom surface 2d is received by the light receiver 7B. Before and after the stick 2 is pushed, the distance between the optical sensor 7 and the bottom surface 2d of the stick 2 differs, and thus, the state of the light (in other words, a detection signal) received by the optical sensor 7 differs before and after the push. For example, the duration or the distance from the light emission to the light reception, the amount of received light, the direction of received light, or distribution of received light differs. Thus, the sensor board 4 including the optical sensor 7 can detect or calculate, based on the light emission or light reception signal, the position Z1 before the push, the position Z2 after the push, and the amount of the push corresponding to the distance DZ as shown in FIG. 12. In addition to the distance DZ of the maximum push as shown in FIG. 12, when the push is within the range from the distance 0 to the distance DZ, the sensor board 4 can similarly detect or calculate the push amount.

For example, the optical sensor 7 continues light emission and detection when its function is enabled. Thus, the optical sensor 7 can obtain the detection signals in time series and detect the amount of push at each time point as described above.

### Optical Detection During Rotation of Stick

The rotation angle or the position is detected by the optical sensor 7 in the manner described below when the stick 2 is rotated in XY-direction.

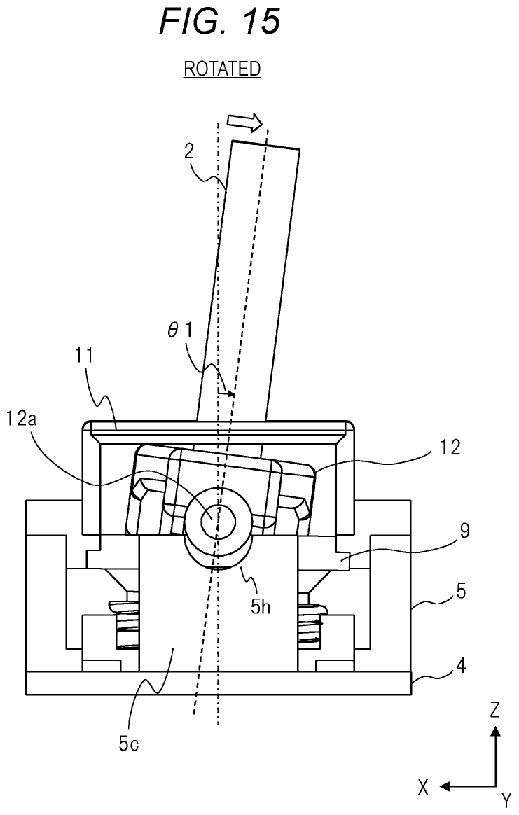

FIG. 15 is an XZ plane view of the stick device 1 when the stick 2 is rotated in X-direction from the neutral position of the stick device 1. The push amount in Z-direction is zero in this example. FIG. 15 does not show the cover 6, and shows, as in FIG. 13, the semicircular recess 5h and the supporter 5c in Y-direction in the base housing 5. The shank 12a in the Y-axis holder 12 is placed above the recess 5h at a distance. FIG. 15 shows the stick 2 rotated at, for example, an angle θ1 in X-direction about the Y-axis of the shank 12a as the rotation central axis 301.

As the stick 2 rotates, the Y-axis holder 12 (e.g., FIGS. 3 and 4) connected to the stick 2 with the shaft 13 similarly rotates in X-direction about Y-axis. The shanks 12a and 12b in the Y-axis holder 12 are located in the spaces of the semicircular recesses 5h and 5i on the supporters 5c and 5d in the base housing 5. The cylindrical shanks 12a and 12b in the Y-axis holder 12 are supported on the recesses 9al and 9b1 (FIG. 11) with the same shape as the supporters 9a and 9b in the stick mount 9. The supporters 9a and 9b in the stick mount 9 have, at the bottom, a prism shape as shown in FIG. 11, and are received in the prism-shaped recesses 5f and 5g on the supporters 5c and 5d in the base housing 5 in FIG. 8. Thus, the stick mount 9 hardly rotates about Y-axis of the Y-axis holder 12.

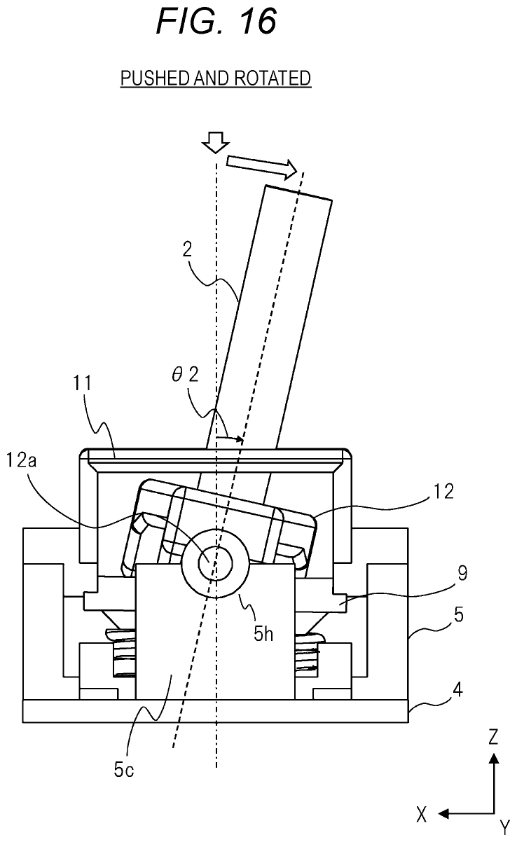

FIG. 16 is an XZ plane view of the stick device 1 with the stick 2 pushed downward in Z-direction in addition to being rotated as in FIG. 15. In other words, in this example, the user rotates the stick 2 in X-direction while pushing the stick 2 downward in Z-direction. FIG. 16 shows the stick 2 at a rotation angle θ2 greater than the rotation angle θ1 in FIG. 15. When the stick 2 is moved downward in Z-direction, the shank 12a in the Y-axis holder 12 is received in and stopped at the space of the semicircular recess 5h on the supporter 5c in the base housing 5.

As shown in FIG. 16, the stick device 1 according to the present embodiment allows the stick 2 to rotate about Y-axis simultaneously with being pushed in Z-direction. The optical sensor 7 can detect the stick 2 in the state in FIG. 16.

FIGS. 17A and 17B are schematic YZ cross-sectional views of some components, describing optical detection of the rotation angle or the position of the stick 2 in XY-direction. FIGS. 17A and 17B show the stick 2 rotated in Y-direction about X-axis (rotation central axis 302 in FIG. 4). FIG. 17A shows the stick 2 not pushed downward in Z-direction and having zero rotation in XY-direction. The point P1 serving as the apex of the stick bottom 2b is at the height position Z1.

FIG. 17B shows the stick 2 pushed downward in Z-direction, rotated in XY-direction, and having, for example, a rotation angle θ3 in Y-direction. The point P1 serving as the apex of the stick bottom 2b is at a height position Z3. The height position Z3 is lower than the height position Z1. The point P1 is at the position Y3 in Y-direction, which deviates from the central axis.

As shown in FIGS. 17A and 17B, the optical sensor 7 at the predetermined position emits light to the bottom surface 2d of the stick bottom 2b with the light emitter 7A through the opening 9e, and the reflected light is received by the light receiver 7B. In FIG. 17B, the conical surface serving as the bottom surface 2d of the stick bottom 2b is inclined more than in FIG. 17A. The stick bottom 2b is movable within the range of the space including the recess 9d and the opening 9e. The recess 9d has an upper portion with a predetermined shape, for example, with a height further lowered in the diameter direction from the central axis toward the outer periphery. The outer periphery of the bottom surface 2d of the stick bottom 2b inclined by the rotation is stopped by the upper portion of the recess 9d with this shape.

In the illustrated example as well, light emission and light reception from the optical sensor 7 to the stick bottom 2b differ with a change of the positions from FIG. 17A to FIG. 17B. Thus, the optical sensor 7 can detect the position of the stick bottom 2b in Z-direction and the rotation angle or the position in XY-direction.

### Optical Detection Method

A specific example of an optical detection method with the optical sensor 7 in the stick device 1 according to the present embodiment will be described. With an optical detection method according to the present embodiment, the optical sensor 7 (the light emitter 7A and the light receiver 7B) directly, or in other words, contactlessly detects the push distance or the position in Z-direction as well as the rotation about X-axis and Y-axis of the stick 2.

A first example of the optical detection method will be described below. As shown in FIGS. 3, 12, 17A, and 17B, the optical sensor 7 emits light, or for example, laser light to the bottom surface 2d of the stick bottom 2b with the light emitter 7A at predetermined short intervals, and receives or detects the reflected light with the light receiver 7B. The sensor board 4 including the optical sensor 7 can calculate the direction and the amount of movement of the stick 2 based on a light emission signal and a light reception signal. More specifically, as shown in, for example, FIGS. 17A and 17B, the sensor board 4 can calculate the distance to the bottom surface 2d of the stick 2 in Z-direction, the position of the apex of the bottom surface 2d, the rotation angle and the position of the stick 2 in the XY plane corresponding to the inclination of the bottom surface 2d of the stick 2.

The optical detection method using the optical sensor 7 is not limited to a single method. For example, the single method may be time-of-flight (ToF) distance measurement, but may be an image capturing method described below. With the time-of-flight method, the distance to the bottom surface 2d of the stick 2 can be calculated based on the time taken by the light emitted from the light emitter 7A to return to the light receiver 7B after the light is incident on the bottom surface 2d of the stick 2. Based on the distance to the bottom surface 2d, the position of the stick 2 in Z-direction or the push amount can be calculated. Instead of a laser sensor, the optical sensor 7 may be a sensor using, for example, infrared rays or light from a light-emitting diode (LED).

### Image Capturing Method

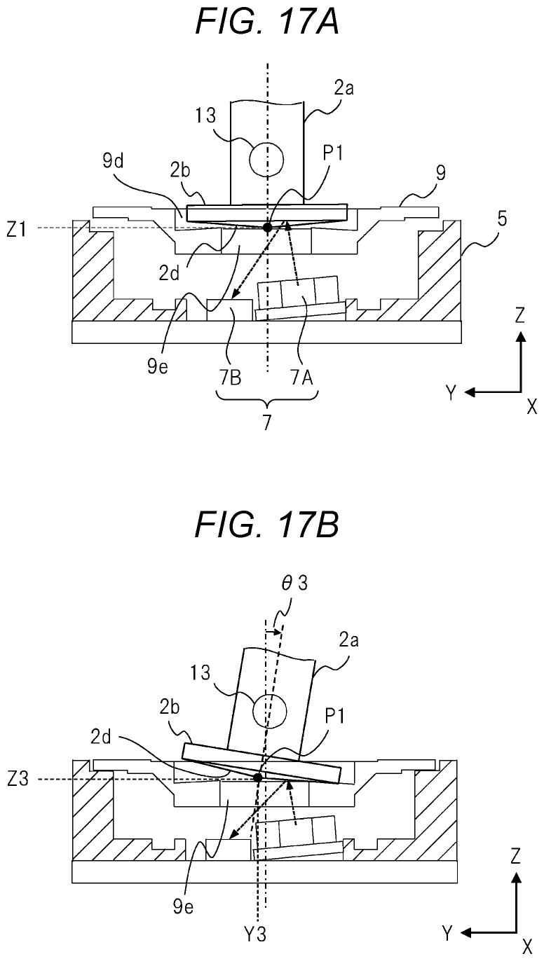

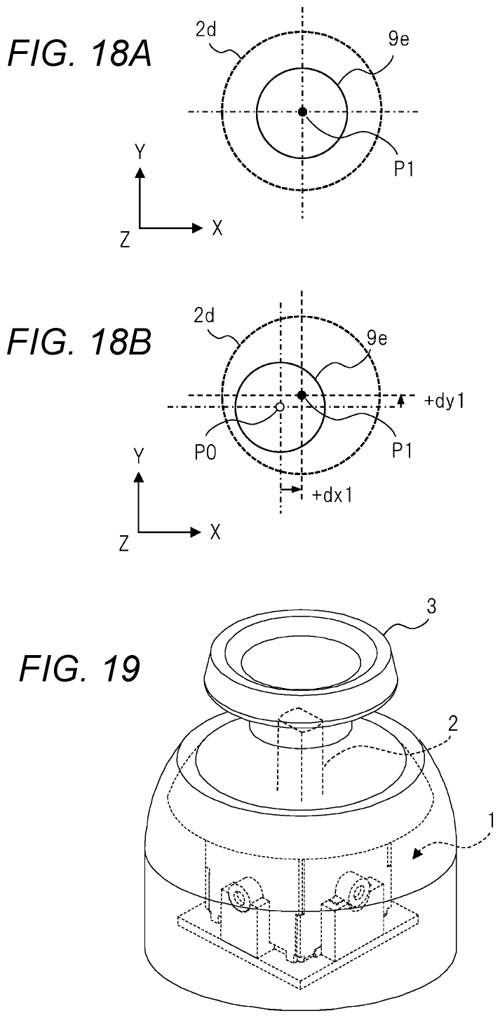

FIGS. 18A and 18B are diagrams describing an image capturing method as another example of the optical detection method. FIGS. 18A and 18B are XY plane views of the bottom surface 2d of the stick bottom 2b viewed from below to above in Z-direction. More specifically, FIGS. 18A and 18B are diagrams of the bottom surface 2d viewed from the optical sensor 7 through the opening 9e in the stick mount 9. The optical sensor 7 used in the image capturing method is an image sensor, or in other words, a camera.

FIG. 18A is a diagram of the bottom surface 2d of the stick 2 at the neutral position. The dotted circle with a larger diameter indicates the profile of the stick bottom 2b, and is not viewable from the optical sensor 7 with the presence of the stick mount 9. The solid circle with a smaller diameter indicates a portion of the bottom surface 2d of the stick bottom 2b viewable from the optical sensor 7 through the opening 9e. The point P1 drawn with a black dot indicates an apex of the cone of the stick bottom 2b, and the position of the central axis of the stick 2.

FIG. 18B shows the stick 2 rotated in X-direction and Y-direction. For example, the point P1 of the stick bottom 2b is moved by a distance+dx1 in X-direction, and by a distance +dy1 in Y-direction. The point P0 is a center point of the opening 9e as an example of a fixed reference position viewed from the optical sensor 7, or in other words, the center point of an image capturing range.

The optical sensor 7 (camera) captures an image of an area including the opening 9e having the point P0 shown in FIGS. 18A and 18B at the center. The sensor board 4 including the optical sensor 7 detects the point P1 of the stick bottom 2b with reference to the point P0 within the captured image, and calculates the direction or the amount (e.g., +dx1 or +dy1) of displacement from the point P0 to the point P1.

The point P1 on the bottom surface 2d of the stick 2 may be marked with a detection mark. In addition to the mark at the point P1, the bottom surface 2d of the stick 2 may be marked with a predetermined detection pattern.

Displacement of the point P1 corresponds to rotation of the stick 2 in XY-direction. Thus, the sensor board 4 can calculate the rotation angle about or the position along X-axis and Y-axis of the stick 2 based on the amount of displacement obtained through image capturing and detection performed by the optical sensor 7.

The structure according to the present embodiment includes one optical sensor 7 (the light emitter 7A and the light receiver 7B as a pair) that detects the state of the bottom surface 2d of the stick 2, but may include multiple optical sensors. For example, two optical sensors (e.g., an optical sensor for X-axis and an optical sensor for Y-axis) may be provided for X-axis and Y-axis, and the optical sensors may detect different portions of the stick bottom surface. The state of the stick 2 such as the rotation angle may be calculated by integrating the detection results from the multiple optical sensors.

In the embodiment, the optical sensor 7 is used as a contactless sensor. In some embodiments, for example, a magnetic sensor may be used.

### Effects

As described above, the stick device according to the first embodiment has higher durability or other characteristics. As described above, when the stick 2 is operated in a triaxial direction, the contact portions are dispersed over multiple portions without being concentrated in a single portion. This structure can prevent or reduce wear or degradation of the components.

A stick device with a known example technique includes two potentiometers and one TACT Switch at the outer periphery of the stick device. In contrast, the stick device according to the embodiment has the contactless structure using the optical sensor 7, eliminating use of two potentiometers and one TACT Switch. Thus, the stick device according to the embodiment has a reduced size.

A stick device with a known example technique detects any push through a contact. In contrast, the stick device according to the present embodiment contactlessly detects the push distance or the position. Thus, the stick device according to the present embodiment can enhance the detection accuracy of a push in Z-direction.

The stick device according to the present embodiment has the new contactless structure and allows a rotation operation in XY-direction simultaneously with a push operation in Z-direction. Thus, in addition to a game controller device, this structure is usable in various devices involving such an operation in a triaxial direction. A stick device with a known technique using contact detection is not appropriate for simultaneous operations on the stick including a rotation operation and a push operation. In contrast, the stick device according to the present embodiment facilitates simultaneous operations on the stick including a rotation operation and a push operation.

The stick device 1 according to the present embodiment is usable as a stick device for various devices such as medical devices, on-board devices, or industrial devices, in addition to a game controller device.

Although one or more embodiments of the disclosure have been described specifically, the disclosure is not limited to the above embodiments, and may be changed in various manners within the range not departing from the gist. Each embodiment may have addition, deletion, or replacement of components except for notable components. Unless particularly noted, each type of component may exist either as a singular component or in plural components. Each embodiment may be combined with a modification.

The technique according to one or more embodiments of the disclosure may provide the structure described below.

(1) A stick device, comprising:
a stick rotatable about a first axis, rotatable about a second axis, and pushable in a direction of a third axis in response to an operation of a user; and
a sensor configured to contactlessly detect a distance of a push on the stick or a position of the stick in the direction of the third axis.

(2) The stick device according to (1), wherein
the stick is rotatable about the first axis and rotatable about the second axis simultaneously with being pushed, and
the sensor detects a rotation angle or a position of the stick about the first axis and a rotation angle or a position of the stick about the second axis.

(3) The stick device according to (1) or (2), further comprising:
a first linkage receiving the stick and rotatable about the first axis;
a second linkage receiving the stick, connected to the stick, and rotatable about the second axis;
a stick mount supporting the second linkage;
a spring supporting the stick mount; and
a base housing supporting the first linkage, the second linkage, the stick mount, and the spring,
wherein, when the stick is pushed, the second linkage and the stick mount move downward along the third axis together with the stick while retaining orientations of the second linkage and the stick mount retained with respect to a plane including the first axis and the second axis.

(4) The stick device according to any one of (1) to (3), wherein
the sensor is an optical sensor or a magnetic sensor located below the stick along the third axis.

(5) The stick device according to any one of (1) to (4), wherein
the sensor is an optical sensor located below the stick mount along the third axis,
the stick mount has an opening aligned with the third axis, and
the optical sensor emits light to a bottom of the stick through the opening and detects reflected light.

What is claimed is:

1. A stick device, comprising:
a stick rotatable about a first axis, rotatable about a second axis, and pushable in a direction of a third axis in response to an operation of a user; and
a sensor configured to contactlessly detect a distance of a push on the stick or a position of the stick in the direction of the third axis.

2. The stick device according to claim 1, wherein
the stick is rotatable about the first axis and rotatable about the second axis simultaneously with being pushed, and
the sensor detects a rotation angle or a position of the stick about the first axis and a rotation angle or a position of the stick about the second axis.

3. The stick device according to claim 1, further comprising:
a first linkage receiving the stick and rotatable about the first axis;
a second linkage receiving the stick, connected to the stick, and rotatable about the second axis;
a stick mount supporting the second linkage;
a spring supporting the stick mount; and
a base housing supporting the first linkage, the second linkage, the stick mount, and the spring,
wherein, when the stick is pushed, the second linkage and the stick mount move downward along the third axis together with the stick while retaining orientations of the second linkage and the stick mount with respect to a plane including the first axis and the second axis.

4. The stick device according to claim 1, wherein
the sensor is an optical sensor or a magnetic sensor located below the stick along the third axis.

5. The stick device according to claim 3, wherein
the sensor is an optical sensor located below the stick mount along the third axis,
the stick mount has an opening aligned with the third axis, and
the optical sensor emits light to a bottom of the stick through the opening and detects reflected light.
